(19) United States
(12) Patent Application Publication
(10) Pub. No.: US 2009/0222246 A1
(43) Pub. Date: Sep. 3, 2009

(54) High-Level, Graphical Programming Language and Tool for Well Management Programming

(76) Inventors: Linh N. Do, Katy, TX (US); John W. Miertschin, Houston, TX (US); Allen R. Kiesling, Abu Dhabi (AE)

Correspondence Address: Gary D. Lawson;ExxonMobil Upstream Research Company, CORP-URX-SW-341, PO Box 2189, Houston, TX, 77252-2189, US

(21) Appl. No.: 11/922,720

(22) PCT Filed: Apr. 25, 2006
(86) PCT No.: PCT/US2006/015385

§ 371 Date: Apr. 16, 2009

Related U.S. Application Data
(60) Provisional application No. 60/694,738, filed on Jun. 28, 2005.

(51) Int. Cl. G06G 7/48; G06F 9/44; G06F 9/45

(52) U.S. Cl. 703/10; 717/109; 717/120; 717/123; 717/106; 717/140

(57) ABSTRACT

A reservoir simulation method, which includes building a hierarchical logic diagram having one or more components. Each component represents a block of programming code. The method further includes converting the hierarchical logic diagram to programming code configured to manage the simulation of a reservoir.

### CROSS REFERENCE TO RELATED APPLICATIONS

This application claims the benefit of U.S. Provisional Application No. 60/694,738, filed 28 Jun. 2005.

### BACKGROUND

1. Field of Inventions

Embodiments of the present inventions generally relate to reservoir simulation, for example, to a well management computer program that may be used in connection with a reservoir simulation computer program used to solve reservoir equations.

2. Description of Related Art

This section is intended to introduce the reader to various aspects of art, which may be associated with exemplary embodiments of the present invention and are described and/or claimed below. This discussion is believed to be helpful in providing the reader with information to facilitate a better understanding of particular techniques of the present invention. Accordingly, it should be understood that these statements are to be read in this light, and not as admissions of prior art.

Reservoir simulation is a process of inferring the behavior of a real reservoir from the performance of a model of that reservoir. Because mass transfer and fluid flow processes in petroleum reservoirs are so complex, reservoir simulations are done using computers. Computer programs that perform calculations to simulate reservoirs are called reservoir simulators. The objective of reservoir simulation is to understand the complex chemical, physical and fluid flow processes occurring in a petroleum reservoir to predict future behavior of a reservoir and to enhance recovery of hydrocarbons. The reservoir simulator can solve reservoir problems that are generally not solvable in any other way. For example, a reservoir simulator can predict the consequences of reservoir management decisions. Reservoir simulation often refers to the hydrodynamics of flow within a reservoir, but in a larger sense it also refers to the total petroleum system which includes the reservoir, the surface facilities, and any interrelated significant activity.

The system of equations used to determine the state of the reservoir at each point in time is solved subject to boundary conditions, such as sink and source terms. For instance, the sink and source terms describe how much fluid is injected into or removed from wells located at various positions in the simulation model. These sink and source terms are specified as functions of time to control the solutions of the equations. Also, they represent operational constraints selected based on how to operate the wells and manage the reservoir.

The sink and source terms that represent well operating rates may be set differently when running a simulation study. Depending on the size and complexity of the simulation model and the objectives of the simulation study, the process of selecting these source and sink terms as functions of time can be very elaborate and may involve writing complex algorithms and programs. The program written to set these well rates and boundary conditions for a simulation model is often referred to as well management logic or well management program. As such, the well management program may be configured to determine various aspects about the well for the duration of the prediction period, such as which wells to produce; at what rates; how to satisfy multiple constraints for different surface equipment; when to shut in and when to reopen wells; when to schedule workovers of wells or drillings of new wells; and how much gas or water to inject at different locations to help maintain reservoir pressure.

Well management programs are typically written by trained programmers in a standard programming language, such as FORTRAN, C or C++, which can often be extensive, i.e., thousands of lines of code are commonly generated. Consequently, a significant amount of time is usually needed to allow the well management program to be designed, implemented, tested and accepted by the end user. Because the program is written in a low-level language, it is not easily readable to the end user. Further, the need to investigate many scenarios that emerge in the course of the prediction study may involve frequent modification of the program in a short amount of time. Because the program is written in a low-level language, the end user has to rely on the programmers to modify the program, which further delays the process.

Therefore, a need exists in the art for an improved method and system for generating a well management program that enables the end user to frequently modify the program.

### SUMMARY

Embodiments of the invention are directed to a reservoir simulation method, which includes building a hierarchical logic diagram having one or more components. Each component represents a block of programming code. The method further includes converting the hierarchical logic diagram to programming code configured to manage the simulation of a reservoir.

In one embodiment, the method further comprises (i.e., includes) displaying the hierarchical logic diagram on a graphical user interface.

In another embodiment, the programming code is one of C++ and FORTRAN.

In yet another embodiment, the hierarchical logic diagram provides a high-level, structured view of the programming code for managing the simulation of the reservoir.

In still yet another embodiment, each component is expandable into one or more subcomponents.

In yet another embodiment, the method further comprises generating a debug code during the conversion of the hierarchical logic diagram to the programming code.

In yet another embodiment, the method further comprises generating a documentation for each component.

In yet another embodiment, the method further comprises executing the programming code to generate a simulated reservoir.

In yet another embodiment, the method further comprises using the simulated reservoir to predict the performance of the reservoir.

In yet another embodiment, the method further comprises using the simulated reservoir to produce hydrocarbons from the reservoir.

In yet another embodiment, the components comprise a facility component configured to describe or define a facility.

In yet another embodiment, the facility comprises one of a well, a platform and a field.

In yet another embodiment, the facility component comprises one or more sequence components, each sequence component configured to mark the start of a main logic section in the programming code.

In still yet another embodiment, each sequence component comprises one or more generic components, each generic component configured to perform one or more logical steps for managing the simulation of the reservoir.

In yet another embodiment, each generic component comprises an if_test component configured to specify a logical condition.

In yet another embodiment, converting the hierarchical logic diagram comprises translating the logical condition for the if_test component to programming code.

In yet another embodiment, converting the hierarchical logic diagram comprises resolving a reference to facility in the programming code for the logical condition.

In yet another embodiment, resolving the reference to facility in the programming code for the logical condition comprises setting the reference to facility to the facility defined by the set_loop component, if the generic component to which the if_test component belongs is part of a set_loop component.

In yet another embodiment, resolving the reference to facility in the programming code for the logical condition further comprises setting the reference to facility to the facility defined by the facility component description, if the generic component to which the if_test component belongs is part of at least one of the sequence components.

In yet another embodiment, resolving the reference to facility in the programming code for the logical condition further comprises setting the reference to facility to the facility that invokes the sequence component this logical condition is part of, if the generic component to which the if_test component belongs is not nested under any set_loop component and if the generic component is part of a sequence component configured as a subroutine.

In yet another embodiment, each generic component comprises a loop component configured to execute a loop construct.

In yet another embodiment, the loop construct is one of a while loop, a for loop and a set_loop.

In yet another embodiment, each generic component comprises a quit_loop_condition configured to determine the termination of the loop construct.

In yet another embodiment, converting the hierarchical logic diagram comprises translating the quit_loop_condition to programming code.

In yet another embodiment, converting the hierarchical logic diagram comprises resolving a reference to facility in the programming code for the quit_loop_condition.

In yet another embodiment, resolving the reference to facility in the programming code for the quit_loop_condition comprises setting the reference to facility to a logical condition defined by an if_test component.

In yet another embodiment, the loop component comprises an if_test component configured to specify a logical condition.

In yet another embodiment, converting the hierarchical logic diagram comprises translating a filter condition for the loop component to programming code.

In yet another embodiment, each generic component comprises an execute_action component configured to execute a command.

In yet another embodiment, converting the hierarchical logic diagram comprises translating a command for the execute_action component to programming code.

In yet another embodiment, converting the hierarchical logic diagram comprises resolving a reference to facility and/or fluid phase in the programming code for the command.

In yet another embodiment, resolving the reference to facility and/or fluid phase in the programming code for the command comprises referring to conditions for an if_test component that defines each generic component to which the execute_action component belongs.

In yet another embodiment, resolving the reference to facility and/or fluid phase in the programming code for the command comprises setting the reference to facility to a facility defined by a set_loop component, if the execute_action component is part of the set_loop component.

In yet another embodiment, the execute_action component refers to a function.

In yet another embodiment, the execute_action component comprises a nested_generic component configured to perform one or more logical operations to manage the simulation of the reservoir.

In yet another embodiment, converting the hierarchical logic diagram comprises translating the execute_action component to programming code.

In yet another embodiment, converting the hierarchical logic diagram comprises translating the generic components to programming code.

In yet another embodiment, each generic component comprises a nested_generic component configured to perform one or more logical operations for managing the simulation of the reservoir.

In yet another embodiment, converting the hierarchical logic diagram comprises translating the sequence components to programming code.

In yet another embodiment, the components comprise a facility component configured to describe or define a facility and converting the hierarchical logic diagram to programming code comprises storing a name for the facility.

In yet another embodiment, converting the hierarchical logic diagram comprises resolving a reference to facility in the programming code for the filter condition.

In yet another embodiment, resolving the reference to facility in the programming code for the filter condition comprises setting the reference to facility to the facility defined by the loop component, if the loop component is a set_loop construct.

In yet another embodiment, the components are grouped into one or more container components.

Embodiments of the invention are also directed to a computer system, which includes a processor and a memory comprising program instructions executable by the processor to build a hierarchical logic diagram having one or more components, wherein each component represents a block of programming code; and to convert the hierarchical logic diagram to programming code configured to manage the simulation of a reservoir.

In one embodiment, the memory further comprises program instructions to display the hierarchical logic diagram on a graphical user interface.

In another embodiment, the programming code is one of C++ and FORTRAN.

In yet another embodiment, the hierarchical logic diagram provides a high-level, structured view of the programming code for managing the simulation of the reservoir.

Embodiments of the invention are also directed a method for predicting the performance of a reservoir. The method includes building a hierarchical logic diagram using a graphical user interface. The hierarchical logic diagram comprises one or more components and each component represents a block of programming code. The method further includes displaying the hierarchical logic diagram through the graphical user interface, converting the hierarchical logic diagram to programming code configured to simulate the performance of a reservoir, and executing the programming code to generate a simulated reservoir.

In one embodiment, the method further comprises using the simulated reservoir to predict the performance of the reservoir.

In another embodiment, the method further comprises using the simulated reservoir to produce hydrocarbons from the reservoir.

In still another embodiment, the hierarchical logic diagram is adjustable.

Embodiments of the invention are also directed at a computer implemented method or simulation system for performing a reservoir simulation. The method comprising building a hierarchical logic diagram representing a well management program, wherein the hierarchical logic diagram comprises one or more components that each represents a block of programming code; decoding the hierarchical logic diagram into low-level programming code; compiling low-level programming code; linking low-level programming code to a reservoir simulation program; generating a reservoir simulation model from the reservoir simulation program; and storing results from the reservoir simulation model.

In addition, the method may include other aspects. For instance, the method may include evaluating a reservoir based on the reservoir simulation model or generating a report on the evaluation. Also, the hierarchical logic diagram may be configured to set the well rates and boundary conditions for the reservoir simulation model. The reservoir simulator model may include a reservoir and facilities, wherein the facilities represent physical equipment in the flow path between a reservoir and a delivery location, wherein the facilities are one or more of platforms, manifolds, pumps, compressors, separators, pipelines and rigs. Further, the simulation of the reservoir simulation model may be utilized to model the chemical, physical and fluid flow processes occurring in a reservoir to predict future behavior of the reservoir and to enhance recovery of hydrocarbons from the reservoir.

### BRIEF DESCRIPTION OF THE DRAWINGS

The foregoing and other advantages of the present technique may become apparent upon reading the following detailed description and upon reference to the drawings described below.

FIG. 1A illustrates an exemplary flow diagram of a method for predicting the performance of a reservoir in accordance with one or more embodiments of the invention.

FIG. 1B illustrates an exemplary flow diagram of a method for building a hierarchical logic diagram in accordance with one or more embodiments of the invention.

FIG. 2 illustrates an exemplary display of the placeholders with the FAC icon and the S icon in accordance with one or more embodiments of the invention.

FIG. 3 illustrates an exemplary preliminary view of a hierarchical logic diagram in accordance with one or more embodiments of the invention.

FIG. 4 illustrates a second exemplary preliminary view of a hierarchical logic diagram in accordance with one or more embodiments of the invention.

FIG. 5 illustrates an OMAX as an example of a predefined condition for use in a well management programming environment in accordance with one or more embodiments of the invention.

FIG. 6 illustrates a third exemplary preliminary view of a hierarchical logic diagram in accordance with one or more embodiments of the invention.

FIG. 7 illustrates an exemplary data window prompting the user to select a loop type in accordance with one or more embodiments of the invention.

FIG. 8 illustrates an exemplary list of predefined conditions in accordance with one or more embodiments of the invention.

FIG. 9 illustrates an exemplary sequence component that has a container component with three separate generic components in accordance with one or more embodiments of the invention.

FIG. 10 illustrates a fourth exemplary preliminary view of a hierarchical logic diagram in accordance with one or more embodiments of the invention.

FIG. 11 illustrates an exemplary predefined condition NoViolation in accordance with one embodiment of the invention.

FIG. 12 illustrates a fifth exemplary preliminary view of a hierarchical logic diagram in accordance with one or more embodiments of the invention.

FIG. 13 illustrates an exemplary selection of a predefined command Decrease ONE_AT_A_TIME in accordance with one or more embodiments of the invention.

FIG. 14 illustrates a sixth exemplary preliminary view of a hierarchical logic diagram in accordance with one or more embodiments of the invention.

FIG. 15 illustrates an exemplary final version of a hierarchical logic diagram without the unselected or undefined components removed in accordance with one or more embodiments of the invention.

FIG. 16 illustrates an exemplary execute_action component having a sequence component configured to calling a function may be displayed in accordance with one or more embodiments of the invention.

FIG. 17 illustrates an exemplary flow diagram of a method for decoding the hierarchical logic diagram in accordance with one or more embodiments of the invention.

FIGS. 18A and 18B illustrate an exemplary flow diagram of a method for decoding a generic component in accordance with one or more embodiments of the invention.

FIG. 19 illustrates an exemplary computer network into which embodiments of the invention may be implemented.

FIG. 20 illustrates an exemplary hierarchical logic diagram with nested_generic components in accordance with one or more embodiments of the invention.

### DETAILED DESCRIPTION

A detailed description is provided below. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it should be recognized that references to the “invention” refer to subject matter recited in one or more, but not necessarily all, of the claims. Each of the inventions is described in greater detail below, including specific embodiments, versions and examples, but the inventions are not limited to these embodiments, versions or examples, which are included to enable a person having ordinary skill in the art to make and use the inventions, when the information in this patent is combined with available information and technology. Various terms as used herein are defined below. To the extent a term used in a claim is not defined below, it should be given the broadest definition persons in the pertinent art have given that term as reflected in one or more printed publications or issued patents.

### Specific Embodiments In Drawings

Various embodiments of the invention relate to reservoir simulation, which is the numerical simulation of flow in three dimensions (3D) of one, two, or three fluid phases in porous and permeable rock. The three fluid phases are hydrocarbon liquid (oil), hydrocarbon vapor (gas), and the aqueous phase (water).

Computer programs are used to build a reservoir simulation model that adequately characterizes rock and fluid properties and to calculate the evolution of the simulation model over time in response to planned well operations to remove saleable fluids and in some cases to replace these with less valuable fluids to maintain pressure.

A reservoir simulation model is built by subdividing (discretizing or gridding) a volume of interest into a large number of polyhedral cells. The number of cells commonly ranges from tens of thousands to hundreds of thousands. The volume of interest is defined areally and vertically by the extent of the oil and gas accumulation and of the water that is in pressure communication with the oil and gas. The area may be several square miles, and the thickness may be hundreds, or even thousands of feet.

The state of a simulation cell is defined by its pressure and its contents, i.e., the amounts of oil, gas, and water within the cell. The goal of simulation is to calculate the evolution through time of the states of the cells. This evolution may be governed by the initial states and by the time-dependent removal of fluid from (production) or addition of fluid to (injection) the system by way of wells.

The state of a cell changes in time because of fluid flow between pairs of neighboring cells or between a cell and a well. Fluid flows from high pressure to low pressure. Pressure gradients are induced by removing fluid from the reservoir (production) or adding fluid to the reservoir (injection) by way of wellbores that penetrate the porous and permeable rock. Within the reservoir, fluid converges on (flows toward) producing wellbores and diverges from (flows away from) injecting wellbores.

In the context of a finite-difference reservoir simulation model, fluid flows are calculated between pairs of neighboring cells, and for cells penetrated by a wellbore, between the cell and the wellbore. For purposes of modeling fluid flow, approximate versions of the relevant equations are written for cells to express the conservation of mass and the relationship between phase flow rate and pressure difference. The simultaneous (approximate) solution of these equations for the collection of cells yields the pressure and contents of each cell at a single time. The equations may be solved to determine the state of the reservoir at each point in time subject to boundary conditions, such as sink and source terms, which describe how much fluid is injected into or removed from wells located at various positions in the simulation model.

The sink and source terms that represent well operating rates may be set differently when running a simulation study. To begin, a history match process may be utilized to validate a simulation model. To assure that the simulation model is a good representation of the actual reservoir, the simulation model is calibrated using historical performance data, which often includes measurements at regular intervals of produced fluid volumes and periodic measurements of pressures in wells. In this phase, the source and sink terms are specified using the data collected for well rates. Then, the simulation model is performed and reservoir properties are adjusted to correspond with the data observed from the field.

After the simulation model is validated, it may then be used to provide predictions to forecast future reservoir and well performances. In this mode of operation, the sink and source terms may be specified even though data for well rates are not available for dates projected into the future. The simulation model may be used to investigate many possible prediction scenarios. For each scenario, some settings may be selected for the set of boundary conditions to investigate possible strategies for operating the reservoir and to comply with various operating constraints.

Whether in history match or in prediction mode, selecting and specifying the boundary conditions to operate a simulation model may not be a simple process and, in many cases, may involve extensive programming. In prediction mode, programming is often utilized to set the well rates and boundary conditions. The program written to set these well rates and boundary conditions for a simulation model is often referred to as well management logic or well management program. As such, the well management program is an added component to the reservoir simulation program used to solve the reservoir equations.

Well management programs are generally designed to be flexible and to address many types of requirements for a reservoir. The program typically includes many steps or blocks of code executable in a predefined sequence for purposes of analyzing constraints and requirements imposed on facilities. If any constraint is violated, the program may perform a series of adjustments to modify well operating conditions until the constraint is no longer violated. For each constraint violation, a number of adjustments may be made and a number of different wells may be candidates for the adjustments. After the well management program is developed and coded, it is typically compiled and linked with the rest of the reservoir simulator code, and the resulting combined software package is used to make prediction studies for the reservoir.

Accordingly, various embodiments of the invention propose a programming solution based on developing a layer of components supported by a graphical interface to create a high-level programming approach. The program is created using a special high-level language through a graphical environment. The resulting program is then converted to a low-level programming language, such as C++, FORTRAN and the like.

In terms of building computer programs, embodiments of the invention represent a paradigm shift because a user builds a program by assembling branches of logic using components as building blocks in a graphical environment, instead of writing low-level C++ instructions in a text editor environment. Accordingly, the embodiments display branches of high-level logic components in a hierarchical format instead of displaying thousands of lines of low-level programming codes. These branches of logic components are configured to be translated into the thousands of lines of low-level programming codes. To make the task of assembling the program even easier, a library of pre-fabricated branches of logic may be developed and made available as additional predefined building blocks.

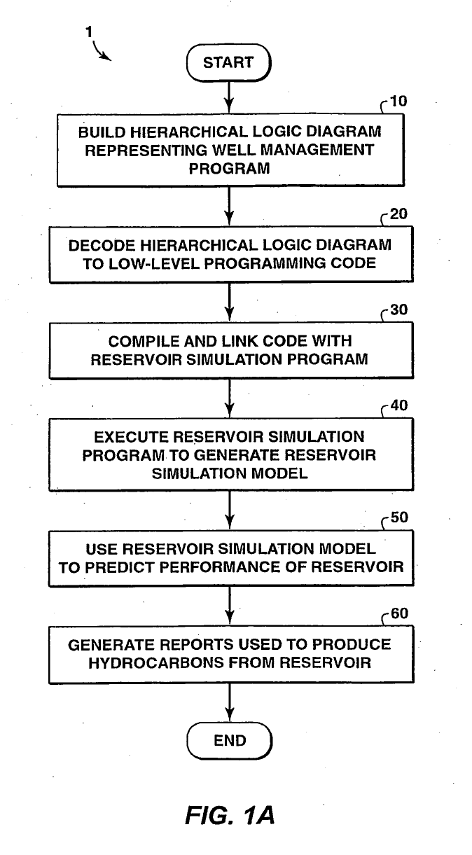

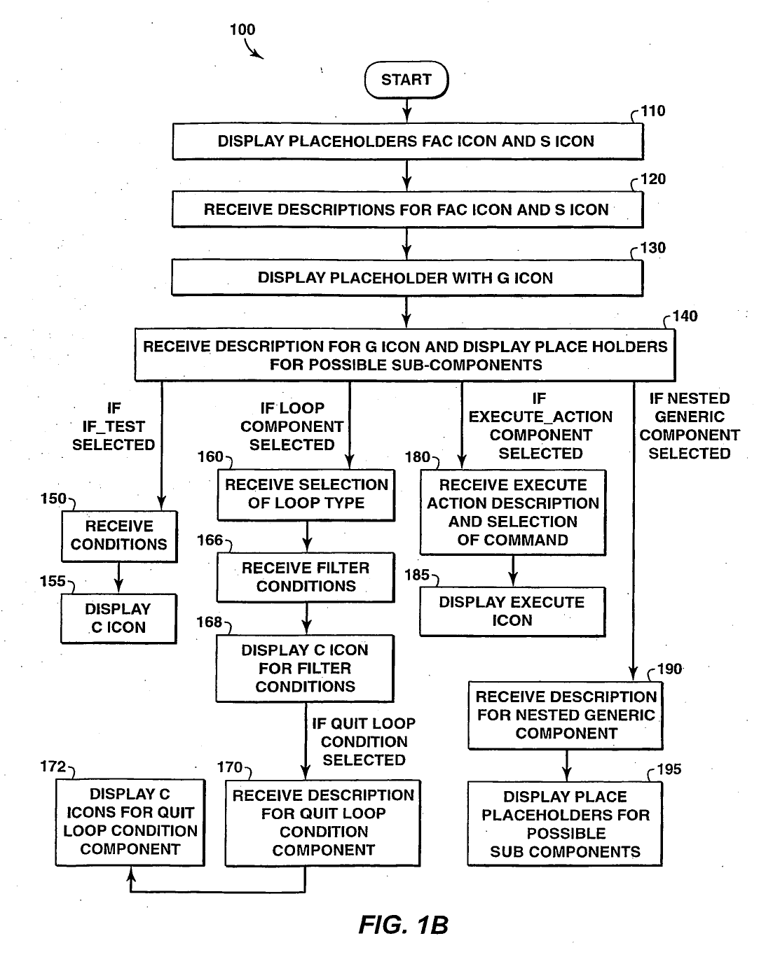

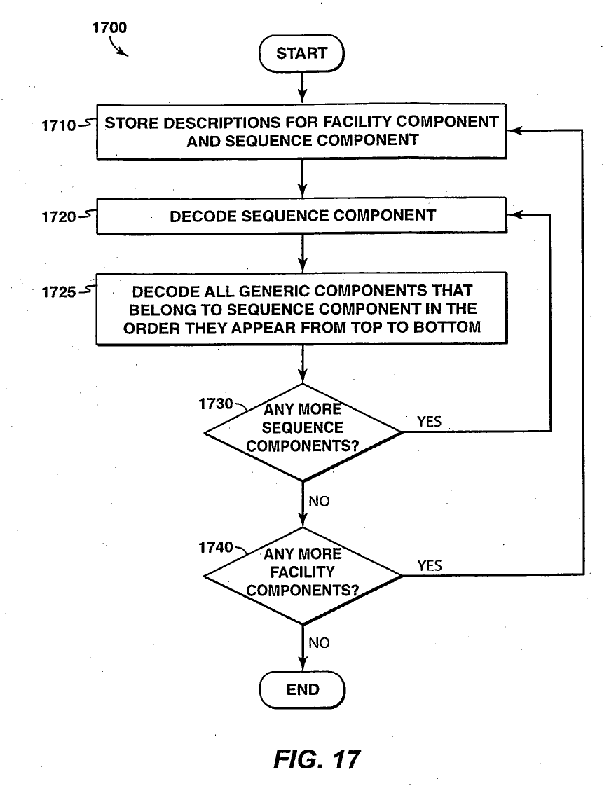

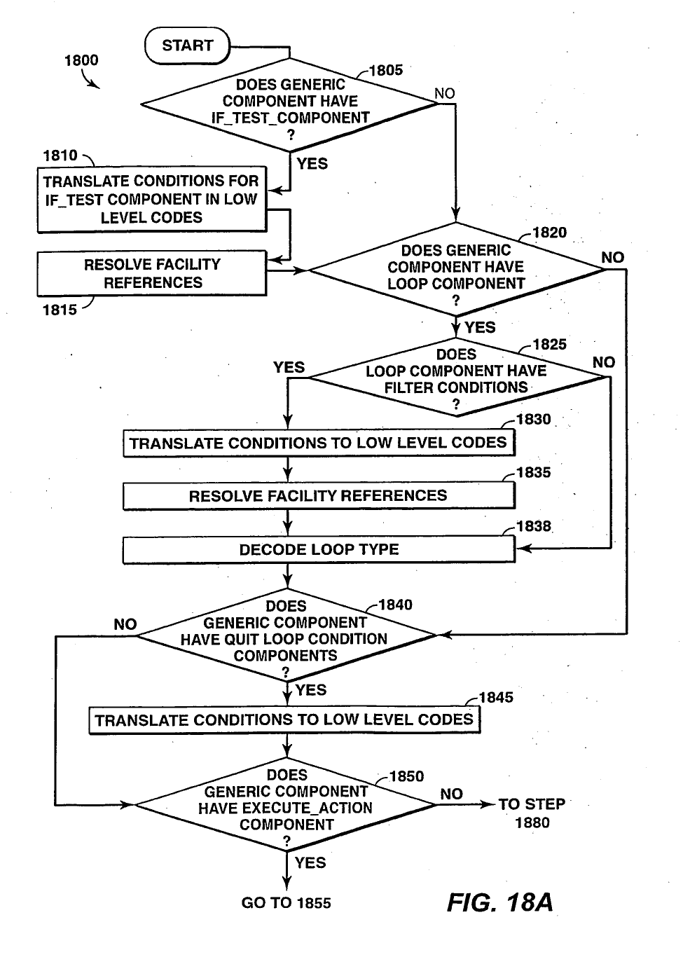

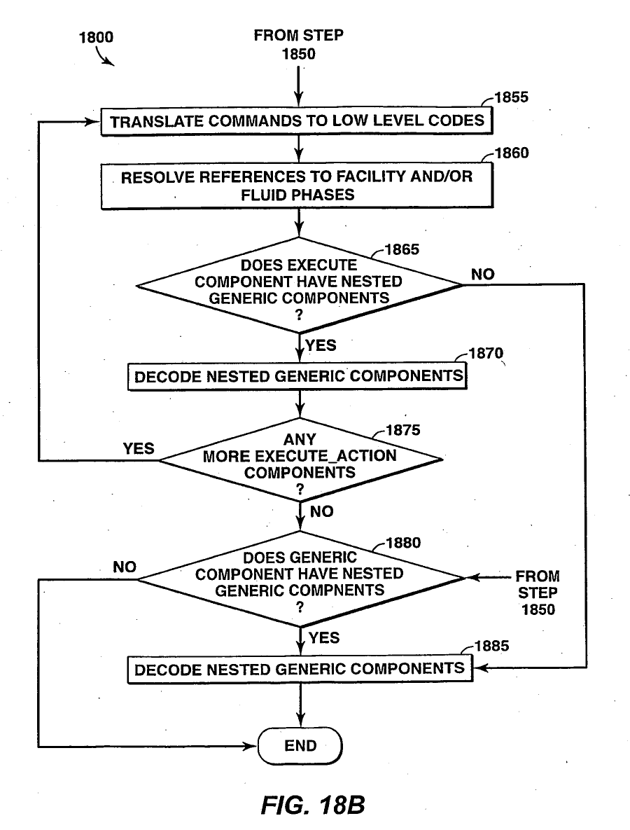

FIG. 1A illustrates an exemplary flow diagram of a method 1 for predicting the performance of a reservoir in accordance with one or more embodiments of the invention. At block 10, a hierarchical logic diagram representing a well management program is built. Various embodiments of the invention are directed to the method for building the hierarchical logic diagram, which is described in more detail in the paragraphs below with reference to FIG. 1B. At block 20, the hierarchical logic diagram is decoded into low level programming code. Various embodiments of the invention are directed to the decoding process, which is described in the paragraphs below with reference to FIGS. 17-18. At block 30, the low level programming code is compiled and linked with a reservoir simulation program. The low level programming code may be complied and linked by conventional methods commonly known by persons of ordinary skill in the art. At block 40, the reservoir simulation program is executed to generate a reservoir simulation model. At block 50, the reservoir simulation model is used to predict the performance of the reservoir. This reservoir simulation model may generate reports that are utilized to produce hydrocarbons from the reservoir, as shown in block 60. The reservoir simulation model may include a reservoir and/or facilities, wherein the facilities represent physical equipment in the flow path between a reservoir and a delivery location. The facilities may include one or more of platforms, manifolds, pumps, compressors, separators, pipelines, rigs and other suitable facilities. Further, the simulation of the reservoir simulation model may be utilized to model the chemical, physical and fluid flow processes occurring in a reservoir to predict future behavior of the reservoir and to enhance recovery of hydrocarbons from the reservoir.

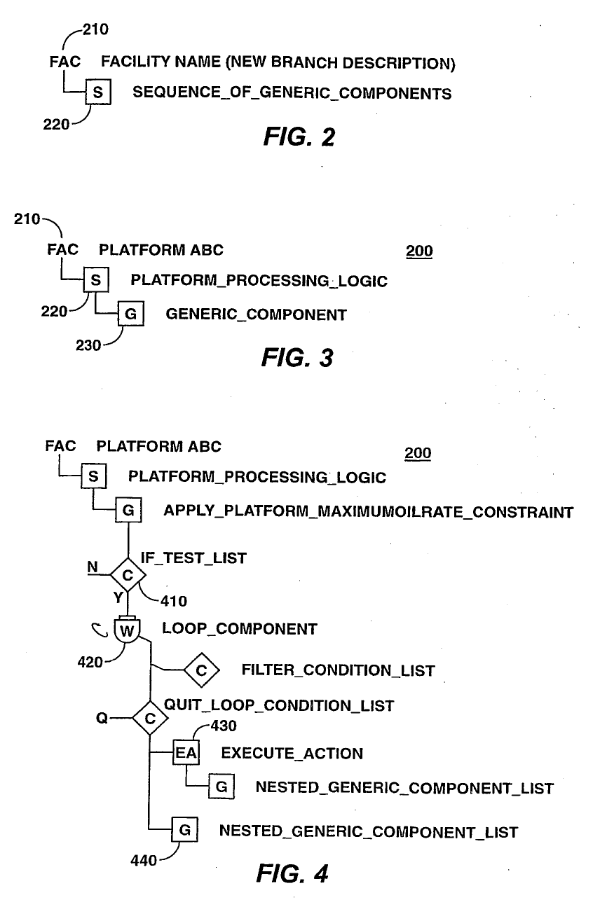

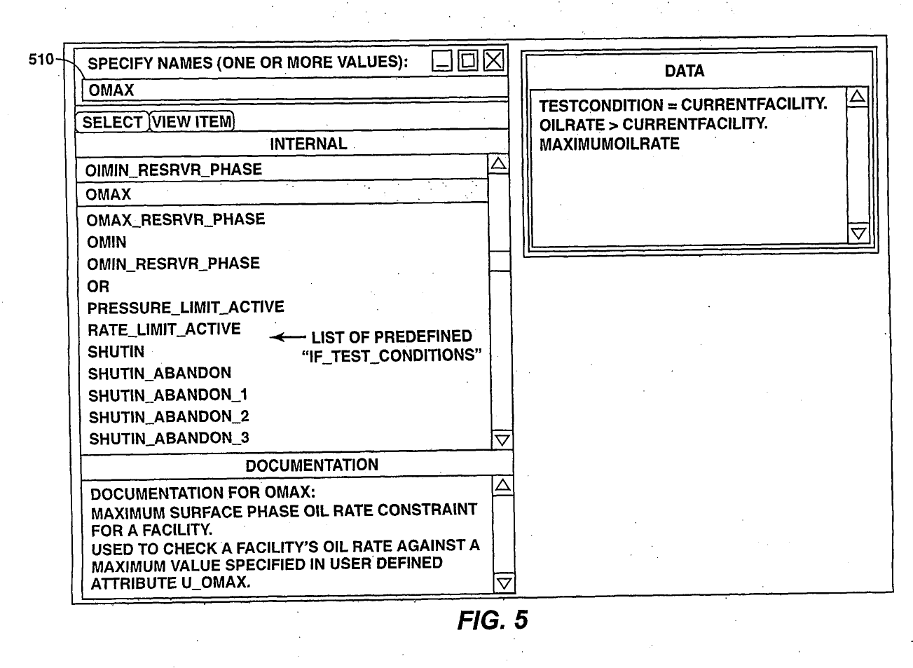

FIG. 1B illustrates an exemplary flow diagram of a method 100 for building a hierarchical logic diagram in accordance with one or more embodiments of the invention. The hierarchical logic diagram may then be translated into a computer language, such as C++, FORTRAN and the like. The decoding and translation process is described below with reference to FIGS. 17-18. A graphical user interface may be used in connection with building the hierarchical logic diagram to facilitate communication between the user and the software application embodiments of the invention. As such, FIGS. 2-4, 6, 10, 12, 14 and 15 illustrate exemplary hierarchical logic diagrams as they are being built in accordance with one or more embodiments of the invention. In addition, FIGS. 5, 7-8, 11 and 13 illustrate various exemplary data windows that may be displayed to build the hierarchical logic diagram.

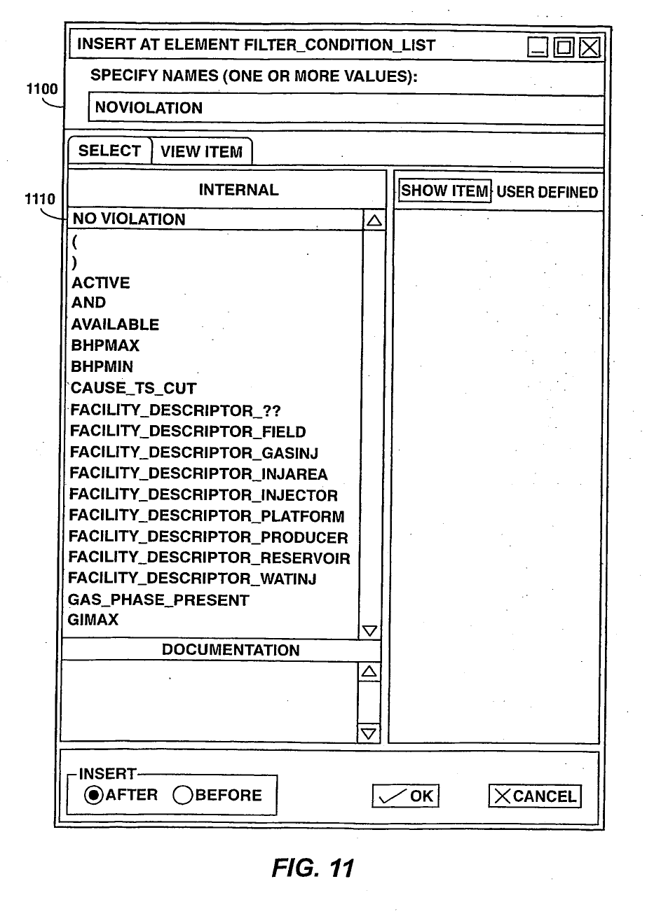

Referring to block 110 in FIG. 11B, a placeholder with an FAC icon and a placeholder with an S icon are displayed on a computer screen. The FAC icon represents the highest level component and the S icon represents the next highest level component within the hierarchy. FIG. 2 illustrates an exemplary hierarchical logic diagram 200 having a placeholder for the FAC icon 210 and a placeholder for the S icon 220 in accordance with one or more embodiments of the invention. The placeholder for the S icon 220 is displayed inwardly indented below the placeholder for the FAC icon 210.

A component as used herein is defined as an object or element used to build the hierarchical logic diagram. Each component represents a block of programming code, which may be generated upon translation of the hierarchical logic diagram to low-level programming code. The translation process is described in detail with reference to FIGS. 18A and 188B. Each component may be defined by input data, which may be translated as part of the low-level programming code.

At block 120, a description for the FAC icon is received from the user. The description may be a name for a facility, such as, a well, a platform, a field and the like. A description for the FAC icon may also be the name of a branch of the hierarchical logic diagram being built. As such, the FAC icon represents the facility component, which is configured to start a new branch of the hierarchical logic diagram and/or to introduce a facility. Referring back to the exemplary hierarchical diagram 200, the description for the facility component is Platform ABC, as shown in FIG. 3. Upon receipt of the description for the facility component, the description is displayed to the user. More than one facility component may be represented in a hierarchical logic diagram.

At block 120, a description for the S icon is also received from the user. The S icon represents a sequence of generic components (“sequence component”), wherein the generic component is the primary component configured to perform some of the logical steps in the hierarchical logic diagram. The generic component is described in more detail below. A sequence component marks the start of a section of logic within the hierarchical logic diagram. The section of logic could be a part of the main program, or the sequence component could introduce a new subroutine. Each facility component may have one or more sequence components. Referring back to the exemplary hierarchical diagram 200, the description for the sequence component is Platform_Processing_Logic, as also shown in FIG. 3.

At block 130, upon receipt of the description of the sequence component, the description is displayed to the user and a placeholder with a G icon is displayed underneath the S icon. Referring back to the exemplary hierarchical diagram 200, a placeholder for the G icon 230 is displayed underneath the placeholder for the S icon 220, as illustrated in FIG. 3. The G icon represents the next highest level component, which is the generic component. Each sequence component may be defined by one or more generic components.

At block 140, upon receipt of the description of the generic component, the description is displayed and one or more placeholders for possible sub-components for the generic component are displayed underneath the G icon. Referring back to the exemplary hierarchical diagram 200, the description for the generic component is Apply_Platform_MaximumOilRate_Constraint, as shown in FIG. 4. The possible sub-components include if_test component, loop component, quit_loop_condition component, execute_action component and nested_generic component. In one embodiment, the possible sub-components are displayed in the order they are to be processed. Each of these sub-components may be used to define the generic component. Referring back to the exemplary hierarchical diagram 200, the if_test component may be represented by a C icon 410, the loop component may be represented by a loop icon 420, the execute_action component may be represented by an EA icon 430 and the nested_generic component may be represented by a G icon 440, all of which are illustrated in FIG. 4. However, it should be noted that while the user may define any order for the sub-components, the order the sub components are displayed and eventually processed follows a predetermined sequence.

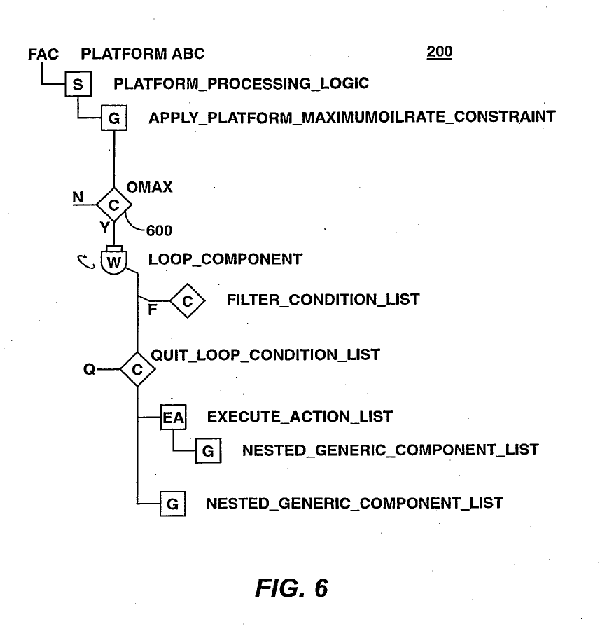

To begin, the if_test component allows the user to specify one or more logical constraints or conditions. If the if_test component is selected by receiving a description for the if_test component, the user may be prompted to select from a list of predefined conditions, as shown in block 150. Examples of predefined conditions for use in a well management programming environment may include testing for violation of a facility's maximum or minimum constraint for oil rate, gas rate, water rate, gas-oil ratio, water-oil ratio, and the like. FIG. 5 illustrates an exemplary data window displaying OMAX 510 as an example of a predefined condition for use in well management programming environment. The low-level programming code for OMAX 510 is TestCondition=CurrentFacility.OilRate>CurrentFacility.MaximumOilRate. OMAX is configured to test the surface phase oil rate for a facility against a maximum surface phase oil rate for that facility. Alternatively, the user may build or specify his/her own condition in block 150. Once the predefined condition is determined, the description for the predefined condition is displayed next to the C icon corresponding to the if_test component, as shown in block 155. Referring back to the exemplary hierarchical diagram 200, OMAX is displayed next to the C icon 600, as illustrated in FIG. 6. More than one if_test condition can be specified joined by “AND” or “OR” operators to define complex test conditions for the generic component.

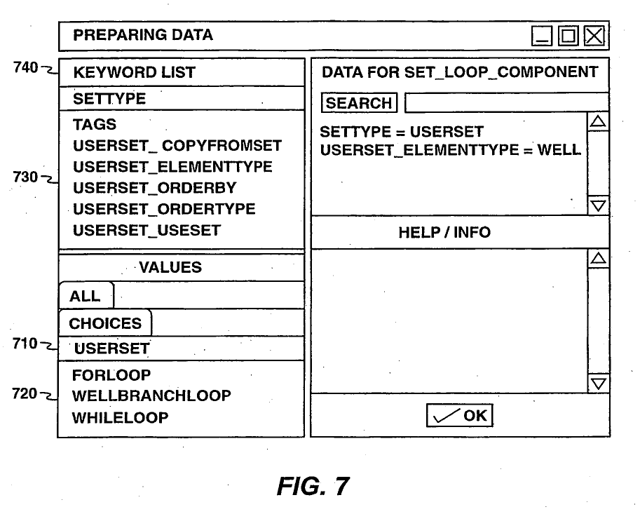

The loop component allows the user to model loop constructs in the desired computer program. Loop constructs are typically used to execute some block of logic in repetitive fashion until some conditions or constraints are met. Examples of loop constructs include while_loop, for loop and set_loop. In well management programming, a set_loop loop construct is commonly used to repeat elements for a set of facilities. For example, a set_loop loop construct may be used to repeat some adjustment for candidate wells in a predefined set of wells. As noted above, the loop component may be selected by receiving a description for the loop component. Based on this selection, the user may be prompted to select a loop type from a list, as shown in block 160. For exemplary purposes, FIG. 7 illustrates an exemplary data window displaying a list of set definition parameters 730 and a list of loop types 720 in accordance with one or more embodiments of the invention. SetType 740 and UserSet 710 have been selected to indicate a set_loop loop construct as the loop type.

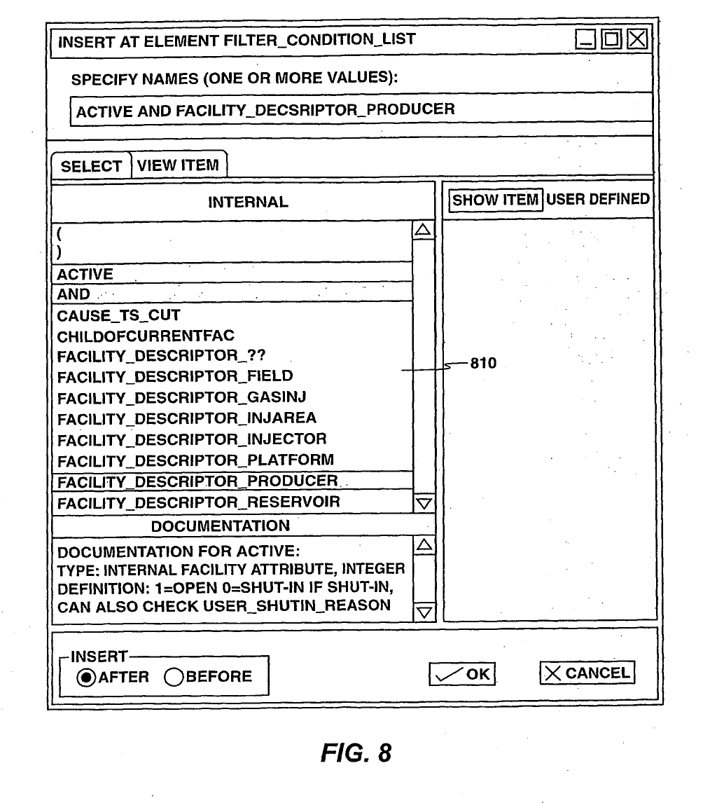

Once the particular loop type is selected, the user may be prompted to specify one or more conditions for the loop component. Conditions for the loop component may commonly be referred to as filter conditions. For set_loop loop constructs, filter conditions define what facilities should be included or excluded from the set of facilities that is to be looped over. An example of a filter condition for use in well management programming includes filtering for a subset of wells with gas rates exceeding some specified value. The user may be prompted to select from a list of predefined conditions 810, as illustrated in FIG. 8. In this exemplary data window, FIG. 8 illustrates that the user has selected predefined conditions ACTIVE AND FACILITY_DESCRIPTOR_PRODUCER. Condition ACTIVE applied to a well refers to a well that is not shut in.

Condition FACILITY_DESCRIPTOR_PRODUCER refers to a well that is a producer well (not an injector). Condition AND is a self-explanatory logical operator. Alternatively, the user may also specify his/her own conditions. Once the conditions are selected or specified, as shown in block 166, a C icon is displayed for each specified condition, as shown in block 168. Referring back to the exemplary hierarchical diagram 200, FIG. 10 shows a loop icon 1000 with description Active_Producers displayed above it and three C icons 1010 with ACTIVE AND FACILITY_DESCRIPTOR_PRODUCER displayed above them.

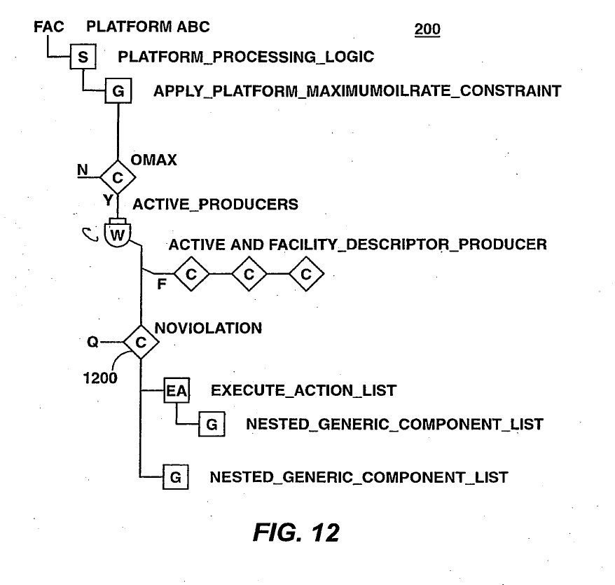

Subsequent to defining the conditions for the loop component, the user may define one or more quit_loop_condition components that are associated with the loop component. A quit_loop_condition component is generally defined by a condition or constraint that determines when the loop terminates or quits. As such, the quit_loop_condition component may often be referred to as a “stop when” condition. The user may be prompted to select from a list of predefined conditions, similar to the manner in which the user is prompted with a list of predefined conditions for the if_test component. FIG. 11 illustrates an exemplary data window 1100 displaying NoViolation 1110 as the selected predefined condition for the quit_loop_condition component. The NoViolation condition is configured to stop the loop operation when the condition defined by the if_test component (e.g., OMAX) is no longer violated. Alternatively, the user may define another condition, as well. Upon receiving a description for the quit_loop_condition component and the conditions for the quit_loop_condition component as shown in block 170, one or more C icons corresponding to the conditions may be displayed with the description adjacent to it, as shown in block 172. Referring back to the exemplary hierarchical diagram 200, FIG. 12 illustrates a C icon 1200 with NoViolation above it.

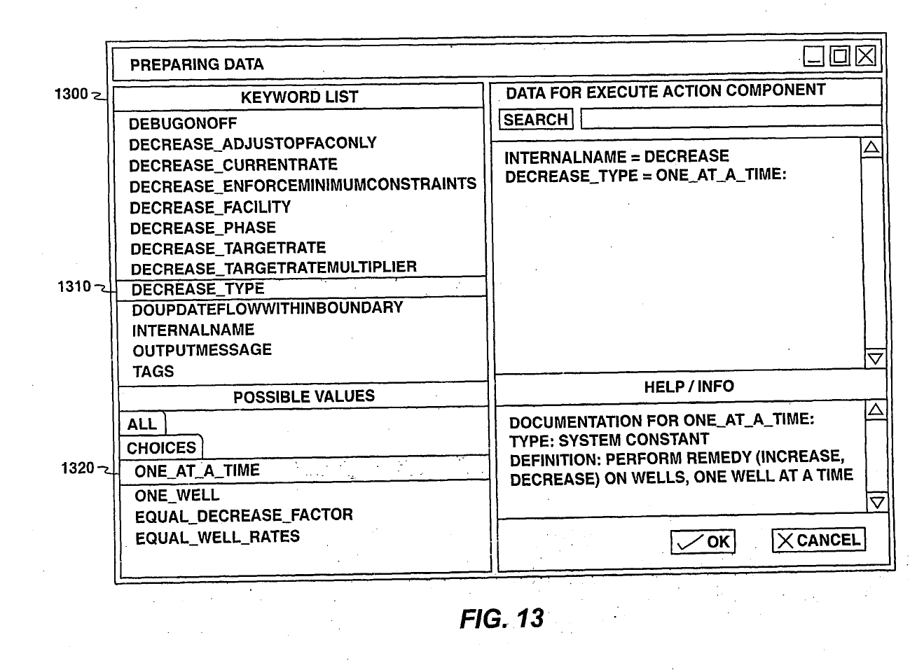

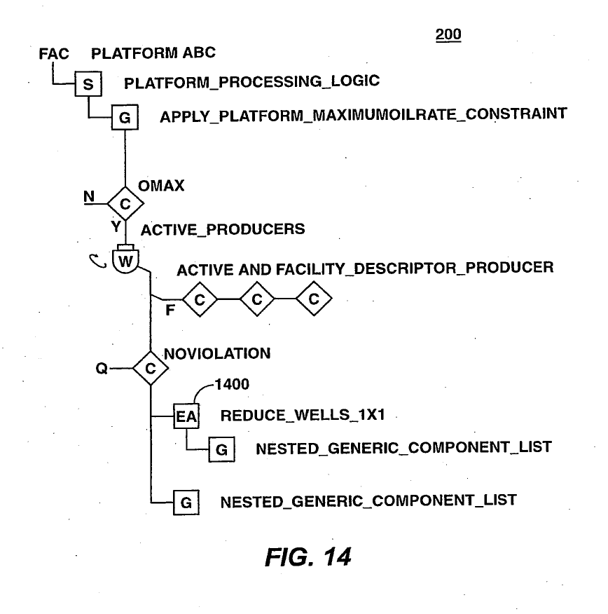

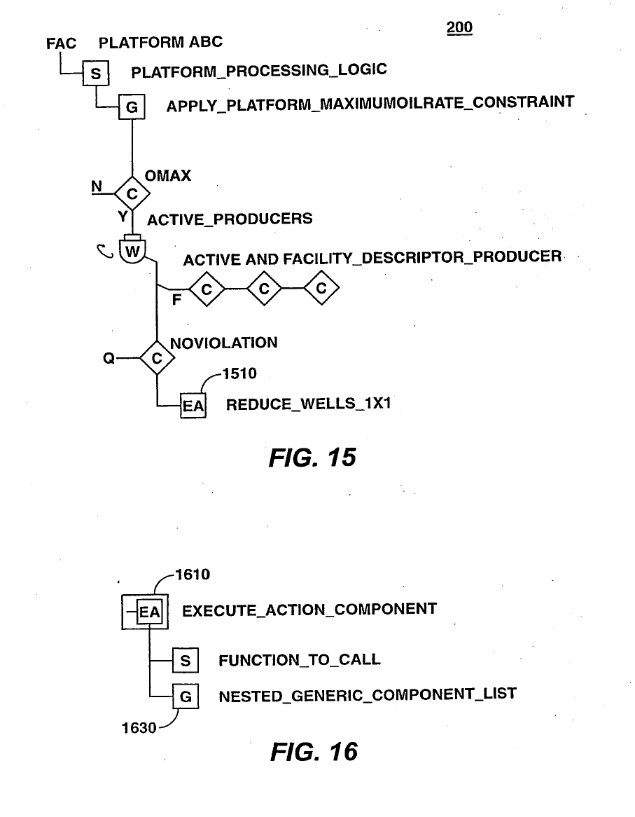

The user may also define one or more execute_action components, which are configured to execute some command or function. Upon receipt of a description for an execute_action component, the user may be prompted to select from a list of predefined commands, as shown in block 180. Examples of commands in a well management programming environment include performing some adjustment on a well, shutting in a well, drilling a well, changing the rate of a well, reducing a well rate and the like. The user may provide additional data to further define the selected command. FIG. 13 illustrates an exemplary data window 1300 with Decrease_Type 1310 and ONE_AT_A_TIME 1320 selected as the predefined command for the execute_action component. At block 185, once the execute_action component has been described and defined, an EA icon is displayed with the description displayed next to it. Referring back to the exemplary hierarchical diagram 200, FIG. 14 illustrates an EA icon 1400 with description Reduce_wells_{—}1×1 displayed next to it. The final version of the hierarchical logic diagram 200 with the unselected or undefined components removed are illustrated in FIG. 15.

Further, the execute_action component may also be defined by a sequence component configured to call a function or subroutine in another embodiment. In this manner, the execute_action component may be configured to call that specific subroutine. As an example, FIG. 16 illustrates an execute_action component 1610 having a sequence component 1620, which is configured to call a function or subroutine. In addition, the execute_action component may include nested_generic components 1630.

A nested_generic component is defined as a generic component inside another generic component (or inside an execute_action component). The nested_generic component may also be represented by a G icon. Upon receipt of the description for the nested_generic component, as shown in block 190, placeholders for possible sub-components for that nested_generic component is displayed underneath the G icon, as shown in block 195. Those sub-components include if_test components, loop components, quit_loop_condition components, execute_action components and also nested_generic components. The user may then select any of these components to define the nested_generic component. Further, each generic component may have more than one nested_generic component. Using this nesting capability, a complex chain of logic can be built with many layers of nested logic with each layer modeled by one or more generic components. In this manner, nested_generic components provide the generic component with flexibility to model complex structures of logic.

If a nested_generic component is selected to define an execute_action component, that nested_generic component may be processed immediately after the execute_action component has been processed. Defining an execute_action component with one or more nested_generic components may be used to process logic that depends on the success or failure of the command defined in the execute_action component. For instance, if the command is first executed, then its success or failure is checked to determine whether another command should be executed. For example, a command to workover a well may be checked to determine if it has succeeded. If the workover has not succeeded, then the well may be shut in.

Although embodiments of the invention are described with reference to one facility component, one sequence component, one generic component and one execute_action component, other embodiments may include hierarchical logic diagrams having one or more facility components, sequence components, generic components and/or execute_action components. The facility components, sequence components, generic components and execute_action components may be processed in the order in which they are displayed from top to bottom.

Once a hierarchical logic diagram is built, the hierarchical logic diagram is decoded into low-level compilable code, such as C++, FORTRAN and the like. The decoding process may take place by performing an “export step” in which all the components of the hierarchical logic diagram are translated into low-level code. A user may also view the low-level code for any component at any time prior to the hierarchical logic diagram being completed. FIG. 17 illustrates an exemplary flow diagram of a method 1700 for decoding the hierarchical logic diagram built using method 100 in accordance with one or more embodiments of the invention. At block 1710, the descriptions for the facility component and the sequence component are stored to memory. Referring back to the exemplary hierarchical logic diagram 200 illustrated on FIG. 15, Platform ABC is stored as the description for the facility component and Platform_Processing_Logic is stored as the description for the sequence component. At block 1720, each sequence component is decoded. The sequence component may be a subroutine that includes a generic component. At block 1725, each generic component for the sequence component is decoded in the order they appear on the hierarchical logic diagram from top to bottom. The decoding process for the generic component is described in detail in the paragraphs below with reference to FIGS. 18A and 18B. At block 1730, a determination is made as to whether the facility component includes any more sequence components. If more sequence components are present, then the next sequence component is processed as shown in block 1720. The sequence components may be processed in the order specified by the hierarchical logic diagram. However, if no more sequence components are present, then a determination is made as to whether the hierarchical logic diagram contains any more facility components, as shown in block 1740. The facility components may also be processed in the order specified in the hierarchical logic diagram. If more facility components are present, then the descriptions for the next facility component and the associated sequence component are stored to memory, as shown in block 1710. However, if no more facility components are present, the process ends. In this manner, all of the facility and sequence components are decoded.

FIGS. 18A and 18B illustrate an exemplary flow diagram of a method for decoding a generic component in accordance with one or more embodiments of the invention. At block 1805, a determination is made as to whether the generic component to be decoded has an if_test component. If an if_test component is present, then the conditions or constraints for the if_test component are translated to low-level programming codes, as shown in block 1810. If the conditions are predefined, then the low-level programming code corresponding to the conditions may be retrieved from a library stored in memory. Referring back to the hierarchical logic diagram 200 in connection with the selection of OMAX described with reference to FIG. 5, the low-level programming code for OMAX is TestCondition=CurrentFacility.OilRate>CurrentFacility.MaximumOilRate. Then, at block 1815, facility references are resolved. That is, any facility reference in the low-level code conditions is resolved. If the generic component associated with the if_test component is embedded in a loop defined by a set_loop component, then the reference to CurrentFacility is set to the facility defined by the loop. Alternatively, if the generic component associated with the if_test component is not embedded in a loop, then the reference to CurrentFacility is set to the facility defined in the facility component description. In continuing with the above referenced example, CurrentFacility is the code variable that refers to a facility in the if_test condition OMAX, and the generic component containing OMAX is not part of a set_loop component. Thus, CurrentFacility is set to Platform ABC, which is the name of a facility for the facility component. If no if_test components are present, then processing continues to block 1820, which is described in detail in the paragraphs below.

At block 1820, a determination is made as to whether the generic component has a loop component. If a loop component is present, the loop component is translated into low-level code. As part of this translation, the loop component may determine whether a loop construct is needed based on what is specified in the context of the components beneath it. If a loop construct is needed, the translation may set up a loop construct and create variables to function as loop counter variables for accessing individual elements. However, if no generic components have loop components, a determination is made as to whether the generic components include execute action components, as described below in block 1850.

At block 1825, a determination is made as to whether the loop component has filter conditions. If no filter conditions exist, the loop type for the loop component is decoded at block 1838. However, if filter conditions exist, then the filter conditions are translated to low-level programming codes, as shown in block 1830. As mentioned above, if the filter conditions are predefined, then the low-level programming codes corresponding to the filter conditions may be retrieved from a library stored in memory. Referring back to the hierarchical logic diagram 200 in connection with the selection of ACTIVE AND FACILITY_DESCRIPTOR_PRODUCER described with reference to FIG. 8, the low-level programming code for the predefined condition ACTIVE may be candidate.get_is_active( ), and the low-level programming code for predefined condition FACILITY_DESCRIPTOR_PRODUCER may be candidate.facility_descriptor=“Producer”. At block 1835, references to facility in the filter conditions are resolved. For instance, if the loop component is a set_loop component, then the facility defined by the set_loop component is made available as the reference facility for use by the components below this set_loop component. Referring back to the hierarchical logic diagram 200 in connection with the selection of Active_Producers described with reference to FIG. 10, Active_Producers is a set_loop component configured to perform a loop over a set of wells. As such, the reference facility for logic below this set_loop component is set to the current well being processed by the Active_Producers set_loop component. The term “candidate” in connection with set_loop component filter conditions refers to a type of facility that is being considered for the set. The type of facility referred by “candidate” is defined by the data for the set_loop component. In this case, Active_Producers is a set_loop component configured to perform a loop over a set of wells, and thus, the term “candidate” refers to wells. Once the facility references are resolved, the loop type for the loop component is decoded at block 1838. The loop type may be a while loop, a for loop or a set loop.

Once the loop component is decoded, a determination is made as to whether the generic component has quit_loop_condition components, as shown in block 1840. If quit_loop_condition components are present, then the conditions are translated to low-level programming code, as shown in block 1845. Yet, if no quit_loop_condition components are present, then processing continues in block 1850, which is described in detail in the paragraphs, below. As mentioned above, if the conditions are predefined, then the low-level programming code corresponding to the conditions may be retrieved from a library stored in memory. In one embodiment, if the quit_loop_condition is the predefined condition NoViolation, then the condition is configured to stop the loop when the condition defined by the if_test component is no longer valid. Accordingly, in such an embodiment, a referral is made to the condition defined for the if_test component. Referring back to the hierarchical logic diagram 200 with reference to FIG. 15, the quit_loop_condition is the predefined condition NoViolation, which refers back to the predefined condition OMAX, which is configured to test the oil rate for a platform against the maximum oil rate.

At block 1850, a determination is made as to whether the generic component has an execute_action component. If an execute_action component is present, the commands for the execute_action component are translated to low-level programming code, as shown in block 1855. If no execute_action component is present, then processing continues to block 1880, which is described in detail in the paragraphs below. As mentioned above, if the commands are predefined, then the low-level programming code corresponding to the predefined commands may be retrieved from a library stored in memory. Referring back to the hierarchical logic diagram 200 with reference to FIG. 13, the low-level programming code for Decrease ONE_AT_A_TIME is a call to a predefined function to decrease well rates one well at a time.

At block 1860, any reference to facility and/or fluid phase in the execute_action component is resolved. In one embodiment, references to fluid phase may be resolved by referring to conditions for the if_test component that define the generic component to which the execute_action component belong. In another embodiment, if the execute_action component is inside a loop created by a set_loop component, then any reference to CurrentFacility is set to the facility defined by the set_loop component. Alternatively, if the execute_action component is not part of a set_loop component, then any reference to CurrentFacility may be set to the facility defined in 1) a previous set_loop component if the current generic component is a component nested inside some previous generic components, or 2) the facility component description. Referring back to the hierarchical logic diagram 200 with reference to FIG. 15, the execute_action component 1510 is paired with the Active_Producers set_loop component 1520, and thus, any reference to CurrentFacility in the low-level code of Decrease ONE_AT_A_TIME is defined by the current well being processed by the Active_Producers set_loop component. In addition, the reference to fluid phase refers back to OMAX, which is the condition for the if_test component. The amount to decrease each well is determined from the constraint OMAX, which references the platform's current oil rate, and from the well rates before and after each decrease adjustment.

At block 1865, a determination is made as to whether the execute_action component has any nested_generic component. If nested_generic components are present, then the nested generic components that belong to the execute action component are decoded according to the blocks described in method 1800 described herein, as shown in block 1870. Referring back to the hierarchical logic diagram 200 with reference to FIG. 15, execute_action component 1510, i.e., Reduce_wells_{—}1×1, has no nested_generic components. Accordingly, after references to facilities and/or fluid phases are resolved at block 1860, processing ends for the first generic component. Referring back to the query at block 1865, if no nested_generic component exists, then processing continues to block 1880, which is described in detail in the paragraphs below.

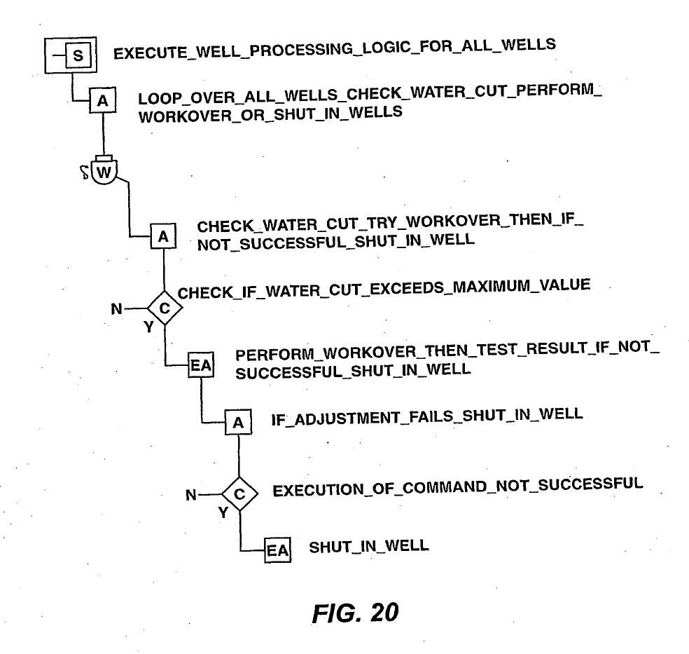

FIG. 20 illustrates a hierarchical logic diagram with nested_generic components in accordance with one or more embodiments of the invention. This embodiment includes a generic component that has a loop component Set of all_wells and a first nested_generic component Check_water_cut_try_workover_then_if_not_successful_shut_in_well. The first nested_generic component includes an if_test component Check_if water_cut_exceeds_maximum_value, which has been predefined as TestCondition=CurrentFacility.water_cut>CurrentFacility.water_cut_maximum, where water_cut=fraction of produced liquid which is water. The first nested_generic component further includes an execute_action component Perform_workover_then_test_result_if_not_successful_shut_in_well, which is configured to close off well perforations to reduce water production in a well. The execute_action component includes a second nested_generic component If_adjustment_fails_shut_in_well, which includes an if_test component Execution_of command_not_successful, which has been predefined to determine whether the current command is successful. Current command refers to the command defined in the execute_action component that is the closest parent of the nested generic component where this if_test component is invoked. In this embodiment, if the workover execute_action is not successful (i.e. the conditional is true), then the well may be shut-in using the execute_action component Shut_in_well.

At block 1875, a determination is made as to whether the generic component has any more execute_action components. If execute_action components are present, then processing returns to block 1855 at which commands for the next execute_action component are translated to low-level programming codes If no execute_action components are present, a determination is made as to whether the generic component has any nested_generic components, as shown in block 1880. If nested_generic components are present, then each nested_generic component is decoded according to the blocks described in method 1800 in the order they are displayed on the hierarchical logic diagram, as shown in block 1885. If nested_generic components are not present, then the processing ends.

In addition to conditions and commands, other components, such as generic component, execute_action component and set_loop component, may also be translated to programming code. For example, a generic component may be configured to inspect its subcomponents and ask the subcomponents to translate themselves into fragments of programming code. Then, the generic component may be configured to take the resulting fragments of code, take care of variable declarations that may be needed, and assemble the pieces together to complete the translation task. Likewise, an execute_action component may be configured to inspect its subcomponents, decide whether it should call a function (if sequence subcomponent is present) or execute some standard command. The execute_action component may also be configured to inspect if any nested_generic subcomponent is defined and if so, activate translation for each nested_generic subcomponent. Similarly, a set_loop component may be configured to determine whether to set up a loop construct or not, and if so, create the variables needed for a loop construct and generate the code for processing the loop construct. Translation of components into low-level code may be performed using object-oriented programming methods and may not necessarily be performed in a linear top-down sequence.

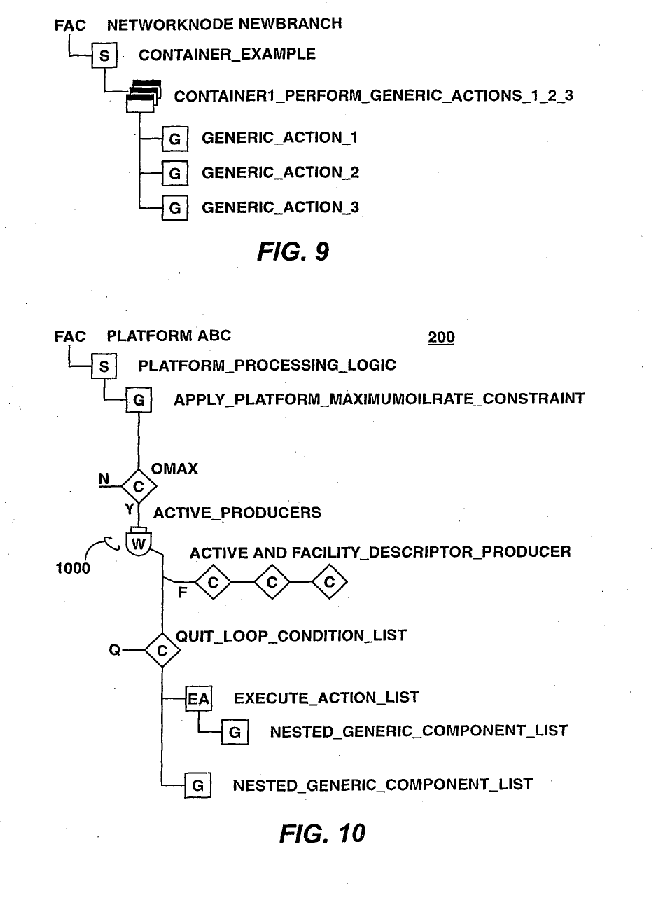

Another type of component that may be created and decoded according to embodiments of the invention described herein is a container component, which may be used to group other components, e.g., sequence component, generic component or execute_action component into a single container, i.e., component. The user may define local variables that are used only within that container. While many variables are automatically set up by the program as needed, there is always a need for the user to be able to specify his/her own local variables. In a graphical user interface environment, the container component may be expanded or contracted. For example, a sequence component may be built to include twenty generic components, which are grouped into four container components of five generic components each. When the sequence component is expanded, the user may only see four container components underneath the sequence component. When a container component is expanded, the user may see the five generic components that make up the expanded container component. FIG. 9 illustrates an example of a sequence component that has a container component with three separate generic components.

Although various embodiments of the invention are described with reference to creating a computer program for purposes of well management, these embodiments may be used to create computer programs for other applications. Furthermore, other embodiments contemplate various combinations of the components to create a set of components better suited for other applications.

Various embodiments described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device may generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high-level procedural or object oriented programming language to communicate with a computer system. However, the program(s) can be implemented in assembly or machine language, if desired. In any case, the language may be a compiled or interpreted language, and combined with hardware implementations.

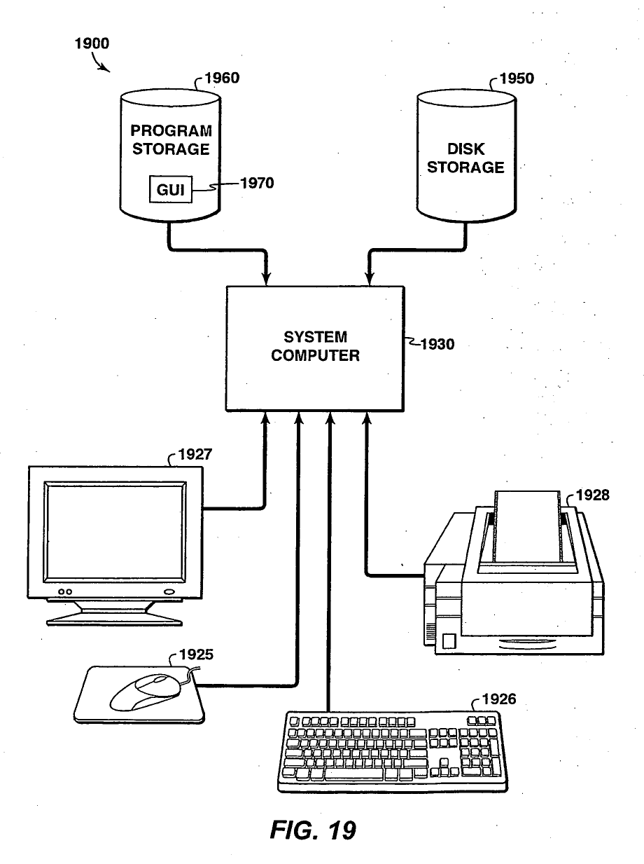

FIG. 19 illustrates a computer network 1900, into which embodiments of the invention may be implemented. The computer network 1900 includes a system computer 1930, which may be implemented as any conventional personal computer or workstation. The system computer 1930 may be in communication with one or more disk storage devices 1950, which may be external hard disk storage devices. It is contemplated that disk storage devices 1950 are conventional hard disk drives, and as such, may be implemented by way of a local area network or by remote access. Disk storage devices 1950 may be used to store any and/or all of the program instructions, measurement data, and results as desired.

In one embodiment, the system computer 1930 may retrieve appropriate data from the disk storage device 1950 to build a hierarchical logic diagram and decode or translate the diagram to low-level programming codes according to program instructions that correspond to the methods described herein. The program instructions may be written in a computer programming language, such as C++, Java and the like. The program instructions may be stored in a computer-readable memory, such as program disk storage device 1960. Of course, the memory medium storing the program instructions may be of any conventional type used for the storage of computer programs, including hard disk drives, floppy disks, CD-ROMs and other optical media, magnetic tape, and the like.

According to a preferred embodiment, the system computer 1930 presents output primarily onto graphics display 1927, or alternatively via printer 1928. The system computer 1930 may store the results of the methods described above on disk storage, for later use and further analysis. The keyboard 1926 and the pointing device (e.g., a mouse, trackball, or the like) 1925 may be provided with the system computer 1930 to enable interactive operation.

In accordance with one embodiment of the invention, the program disk storage device 1960 includes a graphical user interface ˜1970, which allows a user to program by viewing, editing and manipulating branches of logic in a graphical environment. The graphical user interface 1970 is configured to operate with an integrated development environment (IDE). The IDE may include editors that work with logic in both text and graphical modes, cross-reference and search capabilities, expand/collapse features to control display of branches of logic, and comparison tools to compare different branches of logic. The IDE and the ability to work in a graphical environment make the task of building a program and maintaining the program easier and more efficient.

The graphical user interface 1970 provides different controls to create components and build branches of trees. The interface implementation takes advantage of the multi-level component architecture to promote a top-down design and implementation for building a program. In this manner, the program can be built top-down, layer by layer.

One of the many advantages of using the hierarchical logic diagram approach to programming is that it automatically enforces a highly structured design and view of the program. The program is divided into sections of logic with each section represented by a separate branch of logic. Each branch of logic is highly structured, built from a set of building blocks (i.e., components) with fixed architecture. Each branch is built using a top-down process enforced by the graphical interface built into the IDE. Another advantage of embodiments of the invention is that the hierarchical logic diagram offers a high-level, compact version of the entire computer program.

A complex program written in low-level code, such as C++, can be hard to read and follow, even if it is well structured. The code tends to be spread out with many calls to functions that may be nested several layers deep. Using the hierarchical representation of the program offers an easy way to manage the display of logic on the screen. The branches of the hierarchy can be collapsed or expanded to help read and manage the logic, especially when dealing with complex branches. The branches can be collapsed to hide details and display a high-level view of the logic, or they can be expanded to show the detailed information for any selected layer. The branches can be expanded in-line in the same window, or they can be expanded to a new window to help view and manage the screen display. This capability to view logic graphically represents a significant advantage when code walkthroughs need to be performed on the program for quality control. Tasks such as reviewing the program design, performing a detailed analysis of the code and inspecting the logic can be performed more easily and efficiently by hiding/expanding individual layers or branches of the tree. The code walkthroughs can be conducted with the customer participating in the review to make sure that all user specifications are met. The ability to do review and inspection of the logic leads to a better quality program.

To help maintain the program when fast-paced changes are needed, each branch of the tree can be made active or inactive in order to try out different versions of the logic. An inactive branch may be ignored when the final program is translated to a low-level code. The user interface implementation allows a branch to be temporarily deactivated and later reactivated. A special symbol (e.g., an “X”) may be used on the graphical interface to mark a branch as inactive. This functionality allows the user to view and compare different implementations of the logic. Different programming solutions can be maintained and documented within the same program file.

Another advantage of embodiments of the invention involves debugging. Writing debug instructions to help test, debug and validate a C++ program can be a tedious and time-consuming task. A significant benefit derived from embodiments of the invention is the ability to implement automatic debugging techniques, thereby making the validation block more automated and efficient. Each branch of the hierarchy can be made to generate its own debug code during the translation to low-level code. In addition, the hierarchical logic diagram can be used as an accurate roadmap to help track different levels of output generated by the debug code. Each section of debug code can be made to automatically reference a precise location in the hierarchy, where the debug code is configured to create some intermediate output. Because the debug code is only generated at the time of translation to low-level code, it is not displayed with the hierarchical logic diagram and does not interfere with the ability to read the diagram. The automatic debug code generation can be turned on and off during the translation block. For production release of the program, when debug code is no longer needed, turning off the debug code may remove it from the delivered program, thereby avoiding any computation overhead penalty associated with executing the embedded debug code.

Another advantage of embodiments of the invention is directed to documentation. A component may be assigned a unique description, which helps the process of reading and understanding each branch and each layer of the hierarchical logic diagram. This in turn makes it easier to perform code walkthroughs as discussed previously. In addition, the descriptions are used to document the logic implemented by the components. The description can be a high-level pseudo-code that spells out the instruction(s) executable by the component. For example, a description for an if_test component could be Check_if maximum_gas_rate_is_exceeded and a description for a generic component could be Check_minimum_oil_production_rate_and_if_violated_drill_more_wells. Assigning clear and meaningful descriptions to components may therefore result in creating instant documentation for the code, which helps subsequent maintenance of the program. In addition, each component facilitates the user to store additional documentation, including assumptions, explanation, methodology, experience/learning and the like, to help understand the logic and assist with the maintenance of the program.

Another benefit of embodiments of the invention is directed to the ability to delete, copy or paste branches of logic within the hierarchical logic program. To make these operations safe, validation checks may be performed on the hierarchical logic program after each operation. Rules may be programmed into the components to be checked and resolved. The communication model built into the component design allows the components access to data in all layers up and down the hierarchy to resolve rules with context dependency. For example, when copying a branch to a new location, a check is made for possible invalid context. The new location may not have the type of constraint violation test needed to make execution of the copied branch valid. Alternatively, the copied branch may need access to data for a facility (for example, a platform) that is not defined at the destination node. Another common problem includes undeclared local variables. After copying the branch, a check may also be made for local variables that need to be declared and inserted at the destination node.

Another advantage of embodiments of the invention is the ability to create logic that is highly generic and highly reusable. The generic code may be programmed using segments or branches of logic that are context sensitive and contain a minimum amount of hard coded data. Each branch of logic fits in a particular location in the hierarchical tree and can extract information from the surrounding tree to resolve context sensitive instructions. This makes the logic easily “plug-and-playable” to other parts of a program or to other programs. The ability to write generic, plug-and-playable code makes it possible to build a library of templates of reusable logic that can be offered to users to help build their well management programs.

Another common operation performed during the process of assembling the hierarchical logic diagram is to reuse branches of logic built in other programs or from a library of templates. In this case, the manipulation involves copying branches of logic across different “containers” of logic. Additional checks may be performed to make this copy operation safe. Conflicts of component names, data and definitions, and conflicts of variables used in the logic may need to be detected and resolved. The components may be programmed to check for these conflicts and either resolve the conflicts automatically or alert the user to take action when needed. For example, when copying a branch from an external source, some sub-branches of the branch copied may have descriptions that already exist in the destination tree. A check may be performed to see if the components with the same descriptions have the same data/definitions. If the components are complex or compound components, the check may include traversing and comparing each of the nodes that belong to the components. If the definitions agree, no correction block is performed. Otherwise, the copied nodes with description conflicts may automatically be described again to resolve the conflicts, and a warning may be issued to alert the user. These internal checks make copying branches of logic from external sources easier and safer.

While the present techniques of the invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

1. A reservoir simulation method comprising:
building a hierarchical logic tree diagram having one or more components, wherein each component represents a block of programming code which interacts with other components; and
displaying said diagram on a graphical user interface to provide a high-level, structured and graphical view of the programming code; and
converting the hierarchical logic tree diagram to programming code configured to manage the simulation of a reservoir.

3. The method of claim 1, wherein the programming code is one of C++ and FORTRAN.

5. The method of claim 1, wherein each component is expandable into one or more subcomponents.

6. The method of claim 1, further comprising generating a debug code during the conversion of the hierarchical logic diagram to the programming code.

7. The method of claim 1, further comprising generating a documentation for each component.

8. The method of claim 1, further comprising executing the programming code to generate a simulated reservoir.

9. The method of claim 8, further comprising using the simulated reservoir to predict the performance of the reservoir.

10. The method of claim 8, further comprising using the simulated reservoir to produce hydrocarbons from the reservoir.

11. The method of claim 1, wherein the components comprise a facility component configured to describe or define a facility.

12. The method of claim 11, wherein the facility comprises one of a well, a platform and a field.

13. The method of claim 11, wherein the facility component comprises one or more sequence components, each sequence component configured to mark the start of a main logic section in the programming code.

14. The method of claim 13, wherein each sequence component comprises one or more generic components, each generic component configured to perform one or more logical operations to manage the simulation of the reservoir.

15. The method of claim 14, wherein each generic component comprises an if_test component configured to specify a logical condition.

16. The method of claim 15, wherein converting the hierarchical logic diagram comprises translating the logical condition for the if_test component to programming code.

17. The method of claim 16, wherein converting the hierarchical logic diagram comprises resolving a reference to facility in the programming code for the logical condition.

18. The method of claim 17, wherein resolving the reference to facility in the programming code for the logical condition comprises setting the reference to facility to the facility defined by the set_loop component, if the generic component to which the if_test component belongs is part of a set_loop component.

19. The method of claim 17, wherein resolving the reference to facility in the programming code for the logical condition further comprises setting the reference to facility to the facility defined by the facility component description, if the generic component to which the if_test component belongs is part of at least one of the sequence components.

20. The method of claim 17, wherein resolving the reference to facility in the programming code for the logical condition further comprises setting the reference to facility to the facility that invokes the sequence component of which the logical condition is a part, if the generic component to which the if_test component belongs is not nested under any set_loop component and if the generic component is part of a sequence component configured as a subroutine.

21. The method of claim 14, wherein each generic component comprises a loop component configured to execute a loop construct.

22. The method of claim 21, wherein the loop construct is one of a while loop, a for loop and a set loop.

23. The method of claim 21, wherein each generic component comprises a quit_loop_condition configured to determine the termination of the loop construct.

24. The method of claim 23, wherein converting the hierarchical logic diagram comprises translating the quit_loop_condition to programming code.

25. The method of claim 24, wherein converting the hierarchical logic diagram comprises resolving a reference to facility in the programming code for the quit_loop_condition.

26. The method of claim 25, wherein resolving the reference to facility in the programming code for the quit_loop_condition comprises setting the reference to facility to a logical condition defined by an if_test component.

27. The method of claim 21, wherein the loop component comprises an if_test component configured to specify a logical condition.

28. The method of claim 14, wherein converting the hierarchical logic diagram comprises translating a filter condition for the loop component to programming code.

29. The method of claim 14, wherein each generic component comprises an execute_action component configured to execute a command.

30. The method of claim 29, wherein converting the hierarchical logic diagram comprises translating a command for the execute_action component to programming code.

31. The method of claim 30, wherein converting the hierarchical logic diagram comprises resolving a reference to facility and/or fluid phase in the programming code for the command.

32. The method of claim 31, wherein resolving the reference to facility and/or fluid phase in the programming code for the command comprises referring to conditions for an if_test component that defines each generic component to which the execute_action component belongs.

33. The method of claim 31, wherein resolving the reference to facility and/or fluid phase in the programming code for the command comprises setting the reference to facility to a facility defined by a set_loop component, if the execute_action component is part of the set_loop component.

34. The method of claim 29, wherein the execute_action component refers to a function.

35. The method of claim 29, wherein the execute_action component comprises a nested_generic component configured to perform one or more logical operations to manage the simulation of the reservoir.

36. The method of claim 29, wherein converting the hierarchical logic diagram comprises translating the execute_action component to programming code.

37. The method of claim 14, wherein converting the hierarchical logic diagram comprises translating the generic components to programming code.

38. The method of claim 14, wherein each generic component comprises a nested_generic component configured to perform one or more logical operations for managing the simulation of the reservoir.

39. The method of claim 13, wherein converting the hierarchical logic diagram comprises translating the sequence components to programming code.

40. The method of claim 1, wherein the components comprise a facility component configured to describe or define a facility and wherein converting the hierarchical logic diagram to programming code comprises storing a name for the facility.

41. The method of claim 28, wherein converting the hierarchical logic diagram comprises resolving a reference to facility in the programming code for the filter condition 42. The method of claim 41, wherein resolving the reference to facility in the programming code for the filter condition comprises setting the reference to facility to the facility defined by the loop component, if the loop component is a set_loop construct.

43. The method of claim 1, wherein the components are grouped into one or more container components.

44. A computer system, comprising:
a processor; and
a memory comprising program instructions executable by the processor to:
build a hierarchical logic diagram having one or more components, wherein each component represents a block of programming code; and
convert the hierarchical logic diagram to programming code configured to manage the simulation of a reservoir.

45. The computer system of claim 44, wherein the memory further comprises program instructions to display the hierarchical logic diagram on a graphical user interface.

46. The computer system of claim 44, wherein the programming code is one of C++ and FORTRAN.

47. The computer system of claim 44, wherein the hierarchical logic diagram provides a high-level, structured view of the programming code for managing the simulation of the reservoir.

48. A method for predicting the performance of a reservoir, comprising:
building a hierarchical logic diagram using a graphical user interface, wherein the hierarchical logic diagram comprises one or more components, wherein each component represents a block of programming code;
displaying the hierarchical logic diagram through the graphical user interface;
converting the hierarchical logic diagram to programming code configured to manage the simulation of a reservoir; and
executing the programming code to generate a simulated reservoir model.

49. The method of claim 48, further comprising using the simulated reservoir to predict the performance of the reservoir.

50. The method of claim 48, further comprising using the simulated reservoir to produce hydrocarbons from the reservoir.

51. The method of claim 48, wherein the hierarchical logic diagram is adjustable.

52. The method of claim 48, wherein the programming code is one of C++ and FORTRAN.

53. The method of claim 48, wherein the hierarchical logic diagram provides a high-level, structured view of the programming code for managing the simulation of the reservoir.

54. The method of claim 48, further comprising generating a debug code during the conversion of the hierarchical logic diagram to the programming code.

55. The method of claim 48, wherein the components comprise a facility component configured to describe or define a facility.

56. The method of claim 55, wherein the facility comprises one of a well, a platform and a field.

57. The method of claim 55, wherein the facility component comprises one or more sequence components, each sequence component configured to mark the start of a main logic section in the programming code.

58. The method of claim 57, wherein each sequence component comprises one or more generic components, each generic component configured to perform one or more logical operations to manage the simulation of the reservoir.

59. The method of claim 58, wherein each generic component comprises an if_test component configured to specify a logical condition.

60. The method of claim 59, wherein converting the hierarchical logic diagram comprises translating the logical condition for the if_test component to programming code.

61. The method of claim 60, wherein converting the hierarchical logic diagram comprises resolving a reference to facility in the programming code for the logical condition.

62. The method of claim 61, wherein resolving the reference to facility in the programming code for the logical condition comprises setting the reference to facility to the facility defined by the set_loop component, if the generic component to which the if_test component belongs is part of a set_loop component.

63. The method of claim 61, wherein resolving the reference to facility in the programming code for the logical condition further comprises setting the reference to facility to the facility defined by the facility component description, if the generic component to which the if_test component belongs is part of at least one of the sequence components.

64. The method of claim 61, wherein resolving the reference to facility in the programming code for the logical condition further comprises setting the reference to facility to the facility that invokes the sequence component of which the logical condition is a part, if the generic component to which the if_test component belongs is not nested under any set_loop component and if the generic component is part of a sequence component configured as a subroutine.

65. The method of claim 59, wherein each generic component comprises a loop component configured to execute a loop construct.

66. The method of claim 65, wherein the loop construct is one of a while loop, a for loop and a set loop.

67. The method of claim 65, wherein each generic component comprises a quit_loop_condition configured to determine the termination of the loop construct.

68. The method of claim 67, wherein converting the hierarchical logic diagram comprises translating the quit_loop_condition to programming code.

69. The method of claim 68, wherein converting the hierarchical logic diagram comprises resolving a reference to facility in the programming code for the quit_loop_condition.

70. The method of claim 69, wherein resolving the reference to facility in the programming code for the quit_loop_condition comprises setting the reference to facility to a logical condition defined by an if_test component.

71. The method of claim 65, wherein the loop component comprises an if_test component configured to specify a logical condition.

72. The method of claim 58, wherein converting the hierarchical logic diagram comprises translating a filter condition for the loop component to programming code.

73. The method of claim 58, wherein each generic component comprises an execute_action component configured to execute a command.

74. The method of claim 73, wherein converting the hierarchical logic diagram comprises translating a command for the execute_action component to programming code.

75. The method of claim 73, wherein converting the hierarchical logic diagram comprises resolving a reference to facility and/or fluid phase in the programming code for the command.

76. The method of claim 75, wherein resolving the reference to facility and/or fluid phase in the programming code for the command comprises referring to conditions for an if_test component that defines each generic component to which the execute_action component belongs.

77. The method of claim 75, wherein resolving the reference to facility and/or fluid phase in the programming code for the command comprises setting the reference to facility to a facility defined by a set_loop component, if the execute_action component is part of the set_loop component.

78. The method of claim 73, wherein the execute_action component refers to a function.

79. The method of claim 73, wherein the execute_action component comprises a nested_generic component configured to perform one or more logical operations to manage the simulation of the reservoir.

80. The method of claim 73, wherein converting the hierarchical logic diagram comprises translating the execute_action component to programming code.

81. The method of claim 58, wherein converting the hierarchical logic diagram comprises translating the generic components to programming code.

82. The method of claim 58, wherein each generic component comprises a nested_generic component configured to perform one or more logical operations for managing the simulation of the reservoir.

83. The method of claim 57, wherein converting the hierarchical logic diagram comprises translating the sequence components to programming code.

84. The method of claim 48, wherein the components comprise a facility component configured to describe or define a facility and wherein converting the hierarchical logic diagram to programming code comprises storing a name for the facility.

85. The method of claim 84, wherein converting the hierarchical logic diagram comprises resolving a reference to facility in the programming code for the filter condition.

86. The method of claim 85, wherein resolving the reference to facility in the programming code for the filter condition comprises setting the reference to facility to the facility defined by the loop component, if the loop component is a set_loop construct.

87. A computer implemented method for reservoir simulation comprising:
building a hierarchical logic diagram representing a well management program, wherein the hierarchical logic diagram comprises one or more components that each represents a block of programming code;
decoding the hierarchical logic diagram into low-level programming code;
compiling low-level programming code;
linking low-level programming code to a reservoir simulation program;
generating a reservoir simulation model from the reservoir simulation program; and
storing results from the reservoir simulation model.

88. The method of claim 87 further comprising evaluating a reservoir based on the reservoir simulation model.

89. The method of claim 87 further comprising generating a report on the evaluation.

90. The method of claim 87 wherein the hierarchical logic diagram is configured to set the well rates and boundary conditions for the reservoir simulation model.

91. The method of claim 87 wherein the reservoir simulator model comprises a reservoir and facilities, wherein the facilities represent physical equipment in the flow path between a reservoir and a delivery location.

92. The method of claim 91 wherein the facilities are one or more of platforms, manifolds, pumps, compressors, separators, pipelines and rigs.

93. The method of claim 87 wherein simulation is utilized to model the chemical, physical and fluid flow processes occurring in a reservoir to predict future behavior of the reservoir and to enhance recovery of hydrocarbons from the reservoir.
